(19) United States
(12) Patent Application Publication
(10) Pub. No.: US 2025/0265199 A1
(43) Pub. Date: Aug. 21, 2025

(54) METHOD AND APPARATUS FOR SHARING MEMORY IN COMPUTING SYSTEM

(71) Applicant: ELECTRONICS AND TELECOMMUNICATIONS RESEARCH INSTITUTE, Daejeon (KR)

(72) Inventors: Ji Wook YOUN, Daejeon (KR); Dae Ub Kim, Daejeon (KR); Bup Joong Kim, Daejeon (KR); Chan Ho Park, Sejong-si (KR); Jong Tae Song, Daejeon (KR); Jun Ki Lee, Sejong-si (KR); Kyeong Eun Han, Daejeon (KR)

(21) Appl. No.: 19/018,202

(22) Filed: Jan. 13, 2025

(30) Foreign Application Priority Data
Feb. 20, 2024 (KR) 10-2024-0023958

(51) Int. Cl. G06F 12/1072

(52) U.S. Cl. CPC G06F 12/1072

(57) ABSTRACT

According to an embodiment of the present disclosure, a method for sharing memory in a computing system including a central processor (CPU) node, an accelerator node, and a memory node, the method comprising: receiving, by the memory node, an optical link frame including a request of at least one of the CPU node and the accelerator node from an optical module; interpreting the optical link frame; determining whether a physical address included in the optical link frame corresponds to a physical address of a shared memory owned by the memory module included in the memory node; and accessing the shared memory connected to an optical link matcher when the physical address included in the optical link frame corresponds to the physical address of the shared memory owned by the memory module.

### CROSS-REFERENCE TO RELATED APPLICATION

The present application claims priority to Korean Patent Application No. 10-2024-0023958, filed in the Korea Intellectual Property Office on Feb. 20, 2024, the entire contents of which are incorporated herein by reference.

### TECHNICAL FIELD

The present disclosure relates to a method and apparatus for sharing memory in a computing system.

### BACKGROUND

The content described below simply provides background information related to the present embodiment and does not constitute prior art.

A general server-centric computing system is based on a server (a central processor (CPU) server or an accelerator server), in which the CPU and accelerator share memory resources, and memory cannot be shared between different servers. Meanwhile, resource-centric computing systems may share memory between different servers, but there is a problem of available memory imbalance in a CPU node and an accelerator node.

### SUMMARY

In view of the above, the present disclosure provides a method and apparatus for solving the problem of available memory imbalance in a CPU node and an accelerator node, while sharing memory between different servers in a computing system.

The present disclosure provides a method and apparatus for expanding shared memory to a network level in a computing system.

The problems to be solved by the present disclosure are not limited to the problems mentioned above, and other problems not mentioned will be clearly understood by those skilled in the art from the description below.

According to an embodiment of the present disclosure, a method for sharing memory in a computing system including a central processor (CPU) node, an accelerator node, and a memory node, the method comprising: receiving, by the memory node, an optical link frame including a request of at least one of the CPU node and the accelerator node from an optical module; interpreting the optical link frame; determining whether a physical address included in the optical link frame corresponds to a physical address of a shared memory owned by the memory module included in the memory node; and accessing the shared memory connected to an optical link matcher when the physical address included in the optical link frame corresponds to the physical address of the shared memory owned by the memory module.

According to an embodiment of the present disclosure, an apparatus for sharing memory in a computing system including a central processor (CPU) node, an accelerator node, and a memory node, the apparatus comprising: a memory including an instruction; and a processor configured to, by executing the instruction, receive an optical link frame including a request of at least one of the CPU node and the accelerator node from an optical module, interpret the optical link frame, determine whether a physical address included in the optical link frame corresponds to a physical address of a shared memory owned by the memory module included in the memory node, and access the shared memory connected to an optical link matcher when the physical address included in the optical link frame corresponds to the physical address of the shared memory owned by the memory module.

The present disclosure may solve the problem of available memory imbalance in a CPU node and an accelerator node while sharing memory between different servers in a computing system.

The present disclosure may expand shared memory to a network level through an optical switch and an optical link matcher in a computing system.

The effects of the present disclosure are not limited to the effects mentioned above, and other effects not mentioned may be clearly understood by those skilled in the art from the description below.

### BRIEF DESCRIPTION OF THE DRAWINGS

FIG. 1A is a structural diagram of a server-centric computing system, and FIG. 1B is a structural diagram of a resource-centric computing system.

FIG. 2 is a structural diagram of a device that shares memory in a computing system according to an embodiment of the present disclosure.

FIG. 3 is a diagram illustrating a detailed operation of a memory node in a device that shares memory in a computing system according to an embodiment of the present disclosure.

FIG. 4 is a block diagram specifically illustrating an optical link matcher in a memory module of FIG. 3.

FIG. 5 is a block diagram specifically illustrating an optical link matcher in a CPU node or accelerator node according to an embodiment of the present disclosure.

FIG. 6A and FIG. 6B are a diagram of an optical link frame upon a memory read/write request according to an embodiment of the present disclosure.

FIG. 7A and FIG. 7B are a diagram of an optical link frame in the case of a memory read/write response according to an embodiment of the present disclosure.

FIG. 8 is an example illustrating the advantages of a method for increasing a shared memory pool capacity presented in FIG. 4 from a system perspective.

FIG. 9 is a diagram illustrating an operation of a memory sharing system in which there is no optical link matcher in a memory node or there is no switching function in spite of the presence of the optical link matcher in the same scenario as FIG. 8.

FIG. 10 is a flowchart illustrating a method of sharing memory in a computing system according to an embodiment of the present disclosure.

### DETAILED DESCRIPTION

Hereinafter, some embodiments of the present disclosure will be described in detail with reference to the accompanying drawings. In the following description, like reference numerals can designate like elements, even though the elements can be shown in different drawings. Further, the following description of some embodiments can omit, for the purpose of clarity and for brevity, a detailed description of related known components and functions when considered obscuring the subject of the present disclosure.

Various ordinal numbers or alpha codes such as “first”, “second”, “A”, “B”, “(a)”, “(b)”, etc., can be prefixed solely to differentiate one component from the other but not to necessarily imply or suggest the substances, order, or sequence of the components. Throughout this specification, when a part “includes” or “comprises” a component, the part is meant to allow for further including other components and to not exclude other components, unless specifically stated to the contrary. Terms such as “unit,” “module,” and the like can refer to units in which at least one function or operation is processed and they may be implemented by hardware, software, or a combination thereof.

In the present specification, mapping rule and rule have the same meaning, so they will be used interchangeably.

The following detailed description is intended to describe exemplary embodiments of the present invention and is not intended to represent the only embodiments in which the present invention may be practiced.

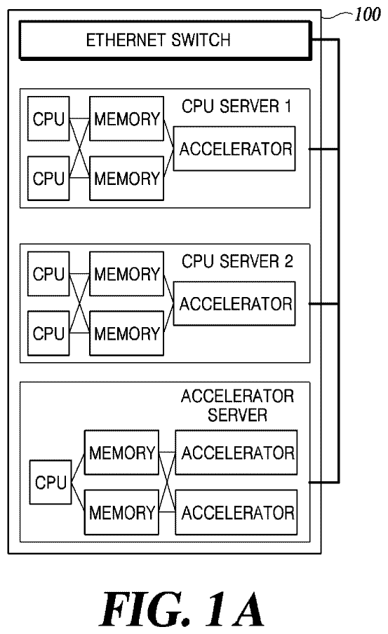

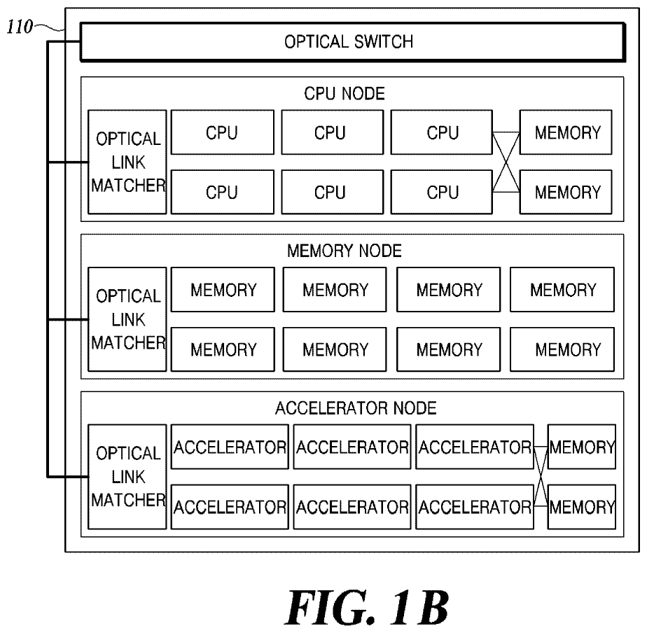

FIG. 1A is a structural diagram of a server-centric computing system, and FIG. 1B is a structural diagram of a resource-centric computing system.

The server-centric computing system 100 in FIG. 1A includes a CPU server, an accelerator server, and an Ethernet switch.

The CPU server includes multiple CPUs, accelerators, and multiple memories, and the multiple CPUs and accelerators within the CPU server share a memory within the CPU server.

The accelerator server includes multiple accelerators, CPUs, and multiple memories, and the multiple accelerators and CPUs within the accelerator server share the memory within the accelerator server. That is, in the server-centric computing system 100, a CPU and an accelerator share memory resources based on a server (a CPU server or an accelerator server), but memory between different servers cannot be shared. For example, in a situation in which a CPU server 1 has enough available memory and a CPU server 2 has insufficient memory, the CPU or accelerator in the CPU server 2 cannot use the memory of the CPU server 1, resulting in an imbalance of available memory between servers. In addition, since shared memory expansion is only made on a server basis, the problem of available memory imbalance between servers cannot be solved even if shared memory is expanded. Also, in the server-centric computing system 100, an Ethernet switch only provides connectivity between servers and cannot support memory resource sharing.

Meanwhile, the resource-centric computing system 110 in FIG. 1B includes a CPU node, a memory node, an accelerator node, and an optical switch.

The CPU node includes multiple CPUs and memory.

The accelerator node includes multiple accelerators and memory.

The memory node includes only multiple memories.

Multiple CPUs constituting the CPU node and multiple accelerators constituting the accelerator node may use the memory within the memory node through an optical link matcher and an optical switch when necessary. That is, the resource-centric computing system 110 shares memory resources on a network basis using the optical link matcher and the optical switch. The memory node provides a memory pool available to all nodes connected through the network. For example, when the memory of the CPU node or accelerator node is insufficient, the corresponding CPU and accelerator may use the memory within the memory node, thereby solving the problem of available memory imbalance. In addition, because shared memory expansion is performed only at the memory node, regardless of the CPU node and accelerator node, shared memory expansion is facilitated and the problem of available memory imbalance between the CPU node and the accelerator node does not occur.

Embodiments of the present disclosure may expand the shared memory of a resource-centric computing system from the conventional server level to the network level, thereby solving the problem of available memory imbalance in the CPU node and the accelerator node and reduce network expansion costs.

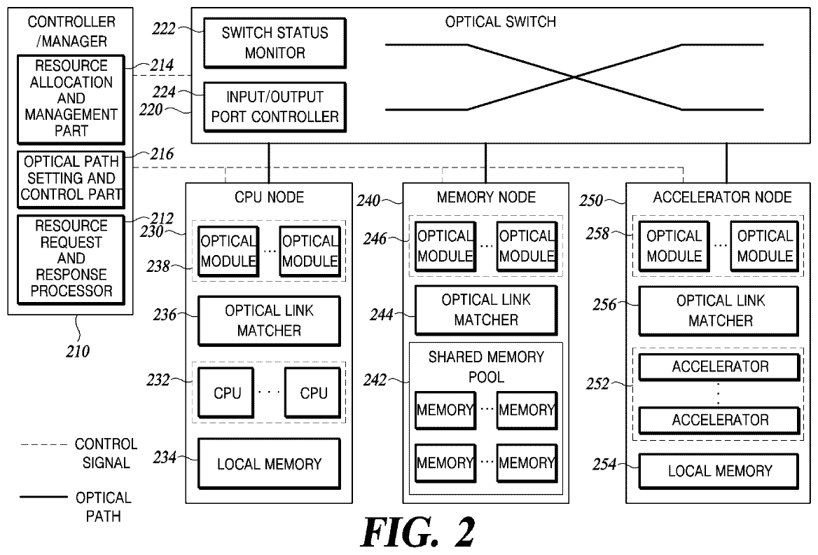

FIG. 2 is a structural diagram of a device that shares memory in a computing system according to an embodiment of the present disclosure.

The device that shares memory in a computing system according to an embodiment of the present disclosure includes a controller/manager 210, an optical switch 220, a CPU node 230, a memory node 240, and an accelerator node 250.

Each node (the CPU node 230, the memory node 240, and the accelerator node 250) is interconnected through an optical switch 220. Each node (the CPU node 230, the memory node 240, and the accelerator node 250) and the optical switch 220 are connected to each other through an optical path (optical fiber).

The controller/manager 210 controls and manages each node (the CPU node 230, the memory node 240, and the accelerator node 250) and optical switch 220 through control signals.

The controller/manager 210 includes a resource request and response processor 212, a resource allocation and management part 214, and an optical path setting and control part 216.

When the CPU node 230 or the accelerator node 250 requests memory resources, the resource request and response processor 212 processes the memory resource request and notifies a corresponding node of the processing result.

The resource allocation and management part 214 manages resources (e.g., the memory, the CPU, the accelerator, etc.) of the memory sharing system and allocates resources by processing resource requests input from the resource request and response processor 212.

The optical path setting and control part 216 controls the optical switch 220 and the optical path of the corresponding node to connect the allocated memory resources to the CPU node 230 or the accelerator node 250.

The optical switch 220 includes a switch status monitor 222 and an input/output port controller 224.

The switch status monitor 222 monitors a current switch status and informs the controller/manager 210 of the current switch status periodically or upon request.

The input/output port controller 224 controls the connection between an input port and an output port of the optical switch 220 according to a control signal input from the controller/manager 210.

The CPU node 230 includes a plurality of CPUs 232, a local memory 234, an optical link matcher 236, an optical module 238, etc.

The plurality of CPUs 232 process various operations and provide a control signal interface with the controller/manager 210.

The local memory 234 stores various information including calculation processing results.

The optical link matcher 236 provides connectivity with other nodes (a CPU, a memory, or an accelerator) through the optical switch 220.

The optical module 238 converts an electrical signal input from the optical link matcher 236 into an optical signal, outputs the optical signal to the optical switch 220, and performs the reverse process.

The accelerator node 250 includes a plurality of accelerators 252, a local memory 254, an optical link matcher 256, an optical module 258, etc.

A plurality of accelerators 252 process various operations and provide a control signal interface with the controller/manager 210.

The local memory 254 stores various information including calculation processing results.

The optical link matcher 256 provides connectivity with other nodes (a CPU, a memory, or an accelerator) through the optical switch 220.

The optical module 258 converts the electrical signal input from the optical link matcher 256 into an optical signal and outputs the optical signal to the optical switch 220, or performs the reverse process.

The memory node 240 includes a shared memory pool 242, an optical link matcher 244, an optical module 246, etc.

The shared memory pool 242 includes a plurality of memories.

The optical link matcher 244 provides connectivity with the CPU node and the accelerator node through the optical switch 220, and provides a control signal interface with the controller/manager 210.

The optical module 246 converts the electrical signal input from the optical link matcher 244 into an optical signal and outputs the optical signal to the optical switch 220, or performs the reverse process.

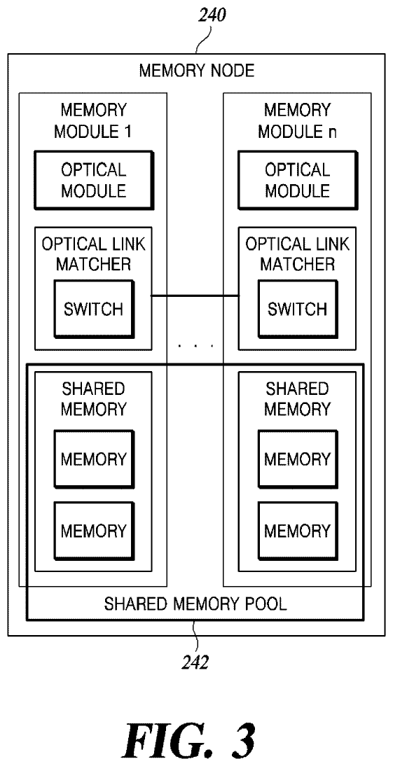

A network-level shared memory expanding method according to an embodiment of the present disclosure is described in detail with reference to FIGS. 3 to 9 as follows.

FIG. 3 is a diagram illustrating a detailed operation of a memory node in a device that shares memory in a computing system according to an embodiment of the present disclosure.

In particular, FIG. 3 shows a method of increasing the capacity of the shared memory pool 242 in the memory node 240 without affecting the operation of the CPU node 230 and the accelerator node 250 according to an embodiment of the present disclosure.

When implemented as hardware, the memory node 240 of FIG. 2 includes a plurality of memory modules 1 to n, as shown in FIG. 3. Each memory module includes a shared memory, an optical link matcher, and an optical module.

The shared memory includes a plurality of memories.

The optical link matcher provides connectivity with the CPU node 230 and the accelerator node 250 through the optical switch 220 and connectivity with other memory modules constituting the memory node through an internal switch.

The optical module converts the electrical signal input from the optical link matcher into an optical signal and outputs the optical signal to the optical switch, or performs the reverse process.

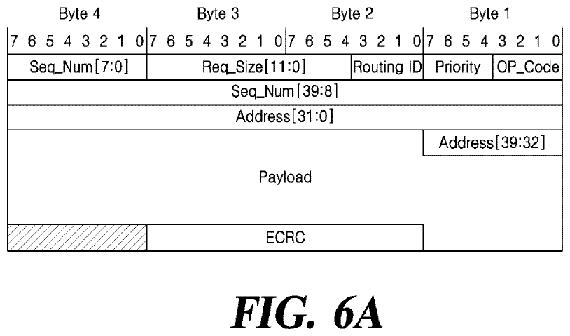

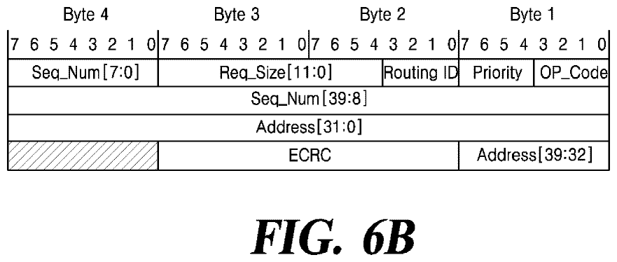

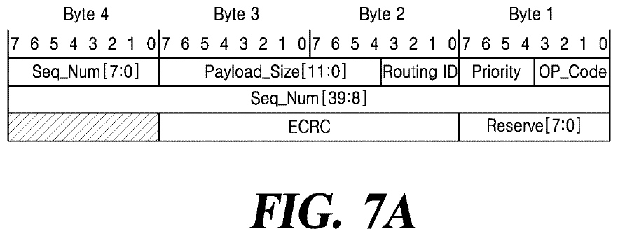

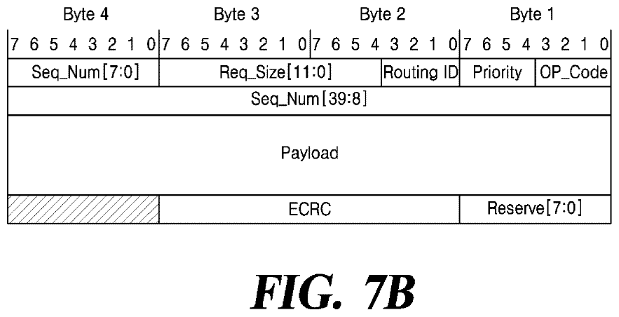

The optical link matcher analyzes an optical link frame input from the optical module and checks a physical address of the shared memory. Thereafter, if the physical address included in the optical link frame corresponds to the physical address of the shared memory owned by the memory module, the optical link matcher accesses the shared memory connected to the optical link matcher. Meanwhile, if the physical address of the shared memory corresponds to a shared memory held by another memory module, the optical link matcher transfers the optical link frame to a memory module having the physical address. Details about the optical link frame is described with reference to FIG. 6A, FIG. 6B, FIG. 7A, and FIG. 7B hereinafter.

Accordingly, the shared memory capacity may be increased without resetting the optical path of the CPU node or accelerator node in FIG. 2, thereby solving the problem of available memory imbalance between the CPU node and the accelerator node.

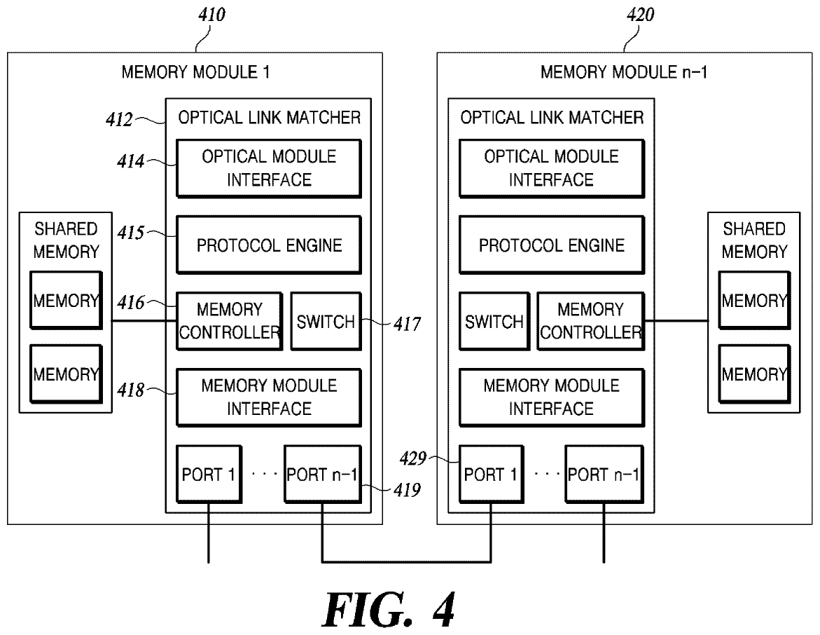

FIG. 4 is a block diagram specifically, illustrating the optical link matcher in the memory module of FIG. 3.

An optical module interface 414 provides an electrical matching function with the optical module.

The protocol engine 415 interprets an optical link frame input from the optical module interface 414 to check the requirements (e.g., memory read/write, priority, etc.) of the CPU node or the accelerator node and a physical address of the shared memory, processes the optical link frame according to the physical address, and outputs the processed optical link frame to a switch 417. At this time, if the physical address of the memory is a memory in the memory module to which a protocol engine 415 belongs, the protocol engine 415 transmits the physical address to a memory controller 416 through the switch 417.

Meanwhile, if the physical address of the memory corresponds to a memory address in a memory module (memory module n-1) other than the memory module to which the protocol engine 415 belongs, the protocol engine 415 changes a routing ID of the optical link frame in FIG. 6A and FIG. 6B to a port number of the optical module by which the optical link frame has been received and transfers the port number to the corresponding memory module (the memory module n-1).

The reason for changing the routing ID to the port number of the optical module by which the optical link frame has been received is that, if the memory request in the memory module n-1 is processed and the result is returned to memory module 1, the optical link matcher of memory module 1 finds out a destination node to which the memory request processing result is to be returned according to the routing ID.

A memory module interface 418 outputs the optical link frame processed by the protocol engine 415 to a port physically connected between memory modules. Each of the above ports has a fixed connection between memory modules and does not have a switching function. For example, port n-1 419 of the memory module 1 410 is physically connected to port 1 429 of the memory module n-1 420.

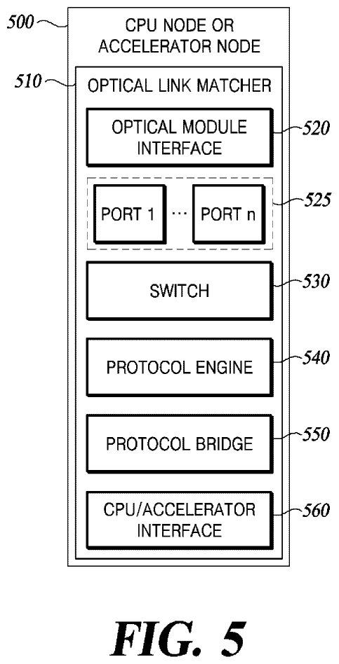

FIG. 5 is a block diagram specifically illustrating an optical link matcher in a CPU node or accelerator node according to an embodiment of the present disclosure.

An optical link matcher in a CPU node or accelerator node 500 includes an optical module interface 520, a switch 530, a protocol engine 540, a protocol bridge 550, and a CPU/accelerator interface 560.

The optical module interface 520 provides an electrical matching function with an optical module.

N ports 525 are respectively directly connected to optical modules connected to the optical module interface 520. That is, although not shown in FIG. 5, the CPU node or accelerator node 500 has N optical modules.

The switch 530 switches optical link frames classified by destination in the protocol engine 540 to the a corresponding to the destination or performs the reverse process.

The protocol engine 540 converts a frame input from the protocol bridge 550 into an optical link frame, outputs the optical link frame to the optical module through the switch 530, and performs the reverse process.

The protocol bridge 550 processes a signal frame input from the CPU or accelerator, converts the same into a form that the protocol engine 540 may decipher, and performs the reverse process. The signal frame output from the CPU or accelerator has a different structure depending on the type of CPU or accelerator, and the type of CPU or accelerator depends on a CPU or accelerator manufacturer.

The CPU/accelerator interface 560 provides a matching function with the CPU or accelerator.

FIG. 6A and FIG. 6B are a diagram of an optical link frame upon a memory read/write request according to an embodiment of the present disclosure.

FIG. 6A and FIG. 6B are a type of optical link frame exchanged through an optical path between nodes (CPU, memory, accelerator) in the memory sharing system of FIG. 2, and FIG. 6A illustrates an example of the optical link frame when the CPU node or accelerator node requests data write into a shared memory located in a memory node. In particular, FIG. 6B shows an example of an optical link frame when the CPU node or accelerator node requests data read from a shared memory located in the memory node.

The write/read request optical link frame includes multiples of 4 bytes to improve frame processing performance in the protocol engine of the optical link matcher.

Write/read request optical link frame includes OP_Code (4 bits), priority (4 bits), routing ID (4 bits), Req_Size (12 bits), Seq_Num (40 bits), Address (40 bits), Payload (at least 1 byte) and End-to-end Cyclic Redundancy Check (ECRC) (16 bits), and the description of each field is shown in Table 1 below. Table 1 shows a description of each field of the optical link frame according to an embodiment of the present disclosure.

TABLE 1

| Field name | Size (bit) | Description |
|---|---|---|
| OP_Code 4 | 4 | Including type(request, response), R/W, Ack/Nak, control |
| | | command |
| Priority | 4 | Processing priority of optical link frame |
| Routing ID | 4 | ID of memory module |
| Req_Size | 12 | Size of data to be read from or write into shared memory |
| Seq_Num | 40 | Sequence number of optical link frame |
| Address | 40 | Start address of shared memory to read or write |
| Payload | >8 | Data to be written into shared memory or data read from |
| | | shared memory |
| ECRC | 16 | CRC for detecting transmission error of optical link frame |
| Reserve | 8 | Field for future use |

More specifically, the write request optical link frame includes a 4-bit OP_Code field, a 4-bit priority field, a 4-bit routing ID, a 12-bit Req_Size field, a 40-bit Seq_Num field, a 40-bit Address field, a Payload field of at least 1 byte, and a 16-bit ECRC field. Also, the read request optical link frame includes a 4-bit OP_Code field, a 4-bit priority field, a 4-bit routing ID, a 12-bit Req_Size field, a 40-bit Seq_Num field, a 40-bit Address field, and a 16-bit ECRC field, etc.

FIG. 7A and FIG. 7B are a diagram of an optical link frame during a memory read/write response according to an embodiment of the present disclosure.

FIG. 7A and FIG. 7B show an example of a response optical link frame to an optical link frame requested by a CPU node or accelerator node to use shared memory located in a memory node.

FIG. 7A shows an example of a write response optical link frame for an optical link frame requested by the CPU node or accelerator node to use shared memory located in a memory node. In particular, FIG. 7B shows an example of a read response optical link frame for an optical link frame requested by the CPU node or accelerator node to use shared memory located in a memory node.

The write/read response optical link frame includes multiples of 4 bytes to improve frame processing performance in the protocol engine of the optical link matcher.

The write/read response optical link frame includes OP_Code (4 bits), priority (4 bits), routing ID (4 bits), Payload/Req_Size (12 bits), Seq_Num (40 bits), Payload (at least 1 byte for only read response), Reserved (8 bits), and ECRC (16 bits), and the description of each field is as shown in Table 1 above.

More specifically, the write response optical link frame includes a 4-bit OP_Code field, a 4-bit priority field, a 4-bit routing ID field, a 12-bit Payload_Size field, a 40-bit Seq_Num field, an 8-bit Reserved field, and a 16-bit ECRC field, etc.

Also, the read response optical link frame includes a 4-bit OP_Code field, a 4-bit priority field, a 4-bit routing ID field, a 12-bit Req_Size field, a 40-bit Seq_Num field, a Payload field of at least 1 byte, an 8-bit Reserved field, and a 16-bit ECRC field.

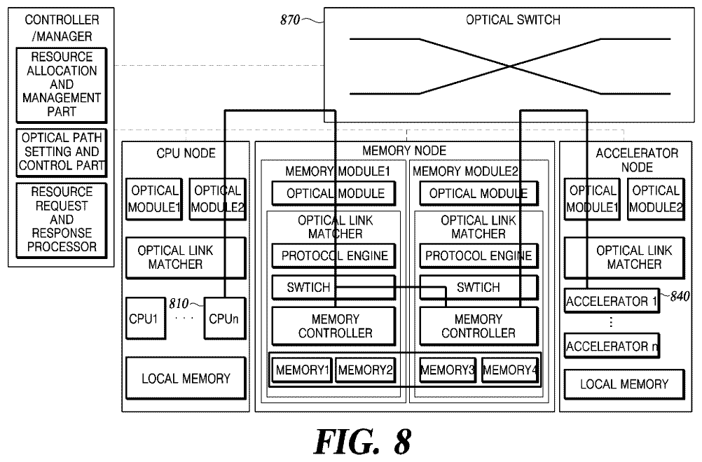

FIG. 8 is an example illustrating the advantages of a method for increasing a shared memory pool capacity presented in FIG. 4 from a system perspective.

A memory module constituting a memory sharing system has a limited number of optical modules. Due to the limitations of the input/output ports of the optical switch, the memory module has fewer optical modules than the number of all CPU nodes or the number of all accelerator nodes constituting the system. For example, memory module 1 and memory module 2 each include one optical module. The CPU node and the accelerator node each include two optical modules.

CPUn 810 of the CPU node is connected to the memory module 1 through the optical module 2 of the CPU node and the optical switch 870.

Accelerator 1 840 of the accelerator node is connected to the memory module 2 through optical module 1 of the accelerator node and the optical switch 870.

It is assumed that CPUn 810 uses memory 1 and memory 2 located in the memory module 1, and accelerator 1 840 uses memory 4 located in the memory module 2.

At this time, when CPUn 810 requests additional memory from the controller/manager, the controller/manager allocates memory 3 located in the memory module 2 and notifies CPUn 810 of an allocation result. Thereafter, the optical link matcher reflects the allocation result in the routing ID and address of the optical link frame shown in FIG. 6 and outputs the same to the memory module 1. The switch of the optical link matcher located in the memory module 1 decodes the optical link frame and switches the corresponding optical link frame to the memory module 2.

As a result, the embodiment of the present disclosure may overcome limitations in the number of input/output ports of the optical switch and flexibly increase memory pool capacity.

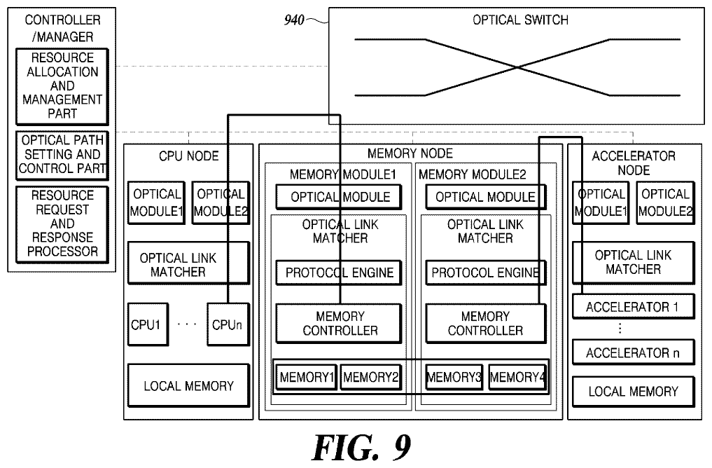

FIG. 9 is a diagram illustrating an operation of a memory sharing system in which there is no optical link matcher in a memory node or there is no switching function in spite of the presence of the optical link matcher in the same scenario as FIG. 8.

In a situation in which accelerator 1 uses memory 4 located in the memory module 2 and CPUn uses memory 1 and memory 2 located in the memory module 1, if CPUn requests additional memory from the controller/manager, the controller/manager rejects the CPUn request because there is no connection path between the CPU node and the memory module 2, and the remaining resources in the memory pool cannot be used.

Meanwhile, after all operations of accelerator 1 are completed, accelerator 1 completes the return of memory 3 located in the memory module 2 through the controller/manager, and when CPUn requests additional memory to the controller/manager, the controller/manager allocates memory 3 located in the memory module 2 to CPUn and sets an optical path between the optical module of the CPU node and the memory module 2. Thereafter, the input/output port connection of the optical switch is reconfigured based on the updated optical path information, which is notified to the CPU node. CPUn of the CPU node transmits an optical link frame to memory 1 and memory 2 based on the optical path setting information input from the controller/manager through optical module 2 of the CPU node. Also, CPUn of the CPU node transmits an optical link frame to memory 3 through optical module 1 of the CPU node based on the optical path setting information input from the controller/manager.

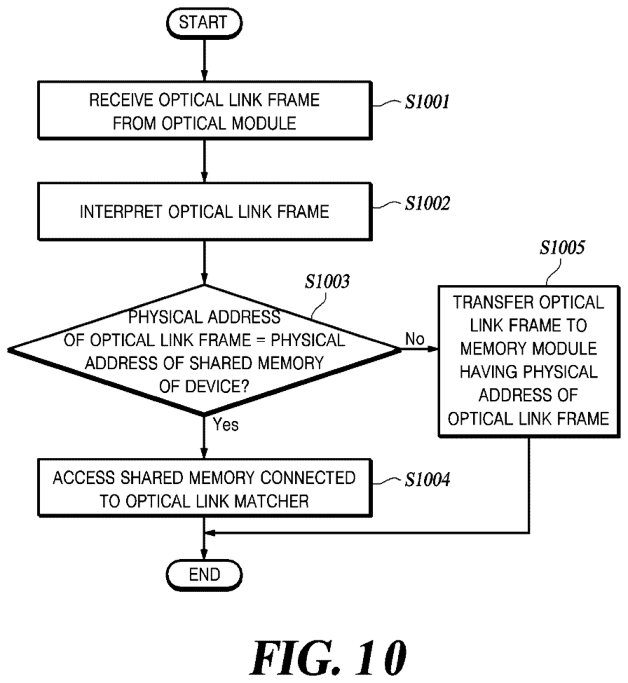

FIG. 10 is a flowchart illustrating a method of sharing memory in a computing system according to an embodiment of the present disclosure.

A device (e.g., a memory node) that shares memory in a computing system receives an optical link frame from an optical module in operation 1001. The optical link frame represents a frame received from a CPU node or accelerator node.

The device that shares memory in a computing system interprets the optical link frame in operation 1002.

The device that shares memory in a computing system determines whether a physical address included in the optical link frame corresponds to a physical address of the shared memory of the device in operation 1003.

If the physical address included in the optical link frame corresponds to the physical address of the shared memory of the device, the device that shares memory in the computing system accesses the shared memory connected to an optical link matcher in operation 1004.

Meanwhile, if the physical address included in the optical link frame does not correspond to the physical address of the shared memory of the device, the device that shares memory in a computing system transfers the optical link frame to the memory module having the physical address included in the optical link frame in operation 1005.

Embodiments of the present disclosure may significantly expand the shared memory range from the conventional server level to the network level. In addition, embodiments of the present disclosure may expand shared memory capacity without affecting the CPU node or accelerator node during a system operation. Embodiments of the present disclosure may reduce construction and operating costs of the memory sharing system by solving the problem of memory imbalance in the CPU node or accelerator node.

At least some of the components described in the exemplary embodiments of the present disclosure can be implemented as a hardware element including at least one or a combination of a digital signal processor (DSP), a processor, a network control unit, an application-specific IC (ASIC), a programmable logic device (FPGA or the like), and other electronic devices. Further, at least some of the functions or processes described in the exemplary embodiments may be implemented as software, and the software may be stored in a recording medium. At least some of the components, functions, and processes described in the exemplary embodiments of the present disclosure may be implemented through a combination of hardware and software.

The method according to the exemplary embodiments of the present disclosure can be written as a program that can be executed on a computer, and can also be implemented as various recording media such as a magnetic storage medium, an optical readable medium, and a digital storage medium.

Implementations of various technologies described herein may be implemented in digital electronic circuitry or in computer hardware, firmware, software, or combinations thereof. The implementations may be implemented as a computer program tangibly embodied in a computer program product, that is, an information carrier such as a machine-readable storage device (computer-readable medium) or a radio signal, for processing using an operation of a data processing device such as a programmable processor, a computer, or a plurality of computers or for control of the operation. Computer programs such as the computer program(s) described above may be written in any form of programming language, including compiled or interpreted languages, and may be deployed in any form included as a stand-alone program or as a module, component, subroutine, or other units suitable for use in a computing environment. The computer program may be deployed to be processed on one computer or a plurality of computers at one site or distributed across a plurality of sites and interconnected by a communications network.

Examples of a processor suitable for processing of the computer program include both general-purpose and special-purpose microprocessors, and any one or more processors of any type of digital computer. Typically, a processor will receive instructions and data from a read-only memory, a random access memory, or both. Elements of the computer may include at least one processor that executes instructions, and one or more memory devices that store instructions and data. Generally, a computer may include one or more mass storage devices that store data, such as magnetic disk, a magneto-optical disk, or an optical disc, or may be combined to receive data from the mass storage devices, transmit data to the mass storage devices, or perform both. Examples of information carriers suitable for embodying of computer program instructions and data include semiconductor memory devices, for example, a magnetic medium such as a hard disk, a floppy disk, and a magnetic tape, an optical medium such as a compact disk read only memory (CD-ROM) and a digital video disc (DVD), a magneto-optical medium such as a floptical disk, a read only memory (ROM), a random access memory (RAM), a flash memory, an erasable programmable ROM (EPROM), and an electrically erasable programmable ROM (EEPROM). The processor and the memory may be supplemented by or included in special purpose logic circuitry.

The processor can execute an operating system and software applications that are executed on the operating system. Further, a processor device may access, store, manipulate, process, and generate data in response to the execution of software. For ease of understanding, the processor device may be described as being used as a single processor device, but those skilled in the art will understand that the processor device includes a plurality of processing elements and/or a plurality of types of processing elements. For example, the processor device may include a plurality of processors or one processor and one network controller. Further, other processing configurations, such as parallel processors, are possible.

Further, a non-transitory computer-readable medium can be any available medium that can be accessed by a computer and includes both a computer storage medium and a transmission medium.

Although the present specification contains details of a large number of specific implementations, these should not be construed as limitations on the scope of any invention or what may be claimed, but rather as description of characteristics that may be unique to a specific embodiment of a specific invention. Specific characteristics described herein in the context of individual embodiments may also be implemented in combination in a single embodiment. On the other hand, various characteristics described in the context of a single embodiment can also be implemented in a plurality of embodiments individually or in any suitable sub-combination. Furthermore, although characteristics may operate in a specific combination and may be described as initially claimed, one or more characteristics from a claimed combination may be excluded from the combination in some cases, and the claimed combination may be changed to a sub-combination or a variant of a sub-combination.

Similarly, although operations are described in the drawings in a specific order, this should not be construed as such operations having to be performed in the shown specific or sequential order or all of shown operations having to be performed in order to obtain desirable results. In a specific case, multitasking and parallel processing may be advantageous. Further, disaggregation of various device components in the above-described embodiments should not be construed as being required in all the embodiments, and it is to be understood that the described program components and devices may generally be integrated together into a single software product or packaged into a plurality of software products.

What is claimed is:

1. A method for sharing memory in a computing system including a central processor (CPU) node, an accelerator node, and a memory node, the method comprising:
receiving, by the memory node, an optical link frame including a request of at least one of the CPU node and the accelerator node from an optical module;
interpreting the optical link frame;
determining whether a physical address included in the optical link frame corresponds to a physical address of a shared memory owned by a memory module included in the memory node; and
accessing the shared memory connected to an optical link matcher when the physical address included in the optical link frame corresponds to the physical address of the shared memory owned by the memory module.

2. The method of claim 1, wherein the determining of whether the physical address included in the optical link frame corresponds to the physical address of the shared memory owned by the memory module includes determining whether the physical address included in the optical link frame corresponds to the physical address of the shared memory owned by the memory module using a routing ID of the optical link frame.

3. The method of claim 1, further comprising:
transmitting the optical link frame to another memory module having the physical address included in the optical link frame, when the physical address included in the optical link frame does not correspond to the physical address of the shared memory owned by the memory module.

4. The method of claim 1, further comprising:
changing a routing ID of the optical link frame to a port number of the optical module from which the optical link frame has been received and transferring the port number to another memory module, when the physical address included in the optical link frame does not correspond to the physical address of the shared memory owned by the memory module.

5. The method of claim 1, wherein the request includes at least one of memory read, memory write, and priority.

6. The method of claim 1, wherein
the computing system further includes an optical switch, and
a plurality of CPUs of the CPU node and a plurality of accelerators of the accelerator node are connected to the shared memory of the memory node through the optical switch and the optical link matcher.

7. The method of claim 1, wherein
the optical link frame includes a write request optical link frame used when the CPU node or the accelerator node requests data write to the shared memory located in the memory node, and
the write request optical link frame includes a 4-bit OP_Code field, a 4-bit priority field, a 4-bit routing ID field, a 12-bit Req_Size field, a 40-bit Seq_Num field, a 40-bit Address field, a Payload field of at least 1 byte, and a 16-bit End-to-end Cyclic Redundancy Check (ECRC) field.

8. The method of claim 1, wherein
the optical link frame includes a read request optical link frame used when the CPU node or the accelerator node requests data read from the shared memory located in the memory node, and
the read request optical link frame includes a 4-bit OP_Code field, a 4-bit priority field, a 4-bit routing ID field, a 12-bit Req_Size field, a 40-bit Seq_Num field, a 40-bit Address field, and a 16-bit ECRC field.

9. The method of claim 1, wherein
the optical link frame includes a write response optical link frame for an optical link frame requested by the CPU node or the accelerator node to use shared memory located in the memory node,
the write response optical link frame includes a 4-bit OP_Code field, a 4-bit priority field, a 4-bit routing ID field, a 12-bit Payload_Size field, a 40-bit Seq_Num field, an 8-bit Reserved field, and a 16-bit ECRC field.

10. The method of claim 1, wherein
the optical link frame includes a read response optical link frame for an optical link frame requested by the CPU node or the accelerator node to use shared memory located in the memory node,
the read response optical link frame includes
a 4-bit OP_Code field, a 4-bit priority field, a 4-bit routing ID field, a 12-bit Req_Size field, a 40-bit Seq_Num field, a Payload field of at least 1 byte, a 8-bit Reserved field, and a 16-bit ECRC field.

11. An apparatus for sharing memory in a computing system including a central processor (CPU) node, an accelerator node, and a memory node, the apparatus comprising:
a memory including an instruction; and
a processor configured to, by executing the instruction,
receive an optical link frame including a request of at least one of the CPU node and the accelerator node from an optical module, interpret the optical link frame, determine whether a physical address included in the optical link frame corresponds to a physical address of a shared memory owned by a memory module included in the memory node, and access the shared memory connected to an optical link matcher when the physical address included in the optical link frame corresponds to the physical address of the shared memory owned by the memory module.

12. The apparatus of claim 11, wherein the processor is configured to determine whether the physical address included in the optical link frame corresponds to the physical address of the shared memory owned by the memory module using a routing ID of the optical link frame.

13. The apparatus of claim 11, wherein the processor is configured to transmit the optical link frame to another memory module having the physical address included in the optical link frame, when the physical address included in the optical link frame does not correspond to the physical address of the shared memory owned by the memory module.

14. The apparatus of claim 11, wherein the processor is configured to change a routing ID of the optical link frame to a port number of the optical module from which the optical link frame has been received and transferring the port number to another memory module, when the physical address included in the optical link frame does not correspond to the physical address of the shared memory owned by the memory module.

15. The apparatus of claim 11, wherein the request includes at least one of memory read, memory write, and priority.

16. The apparatus of claim 11, wherein
the computing system further includes an optical switch, and
a plurality of CPUs of the CPU node and a plurality of accelerators of the accelerator node are connected to the shared memory of the memory node through the optical switch and the optical link matcher.

17. The apparatus of claim 11, wherein
the optical link frame includes a write request optical link frame used when the CPU node or the accelerator node requests data write to the shared memory located in the memory node, and
the write request optical link frame includes a 4-bit OP_Code field, a 4-bit priority field, a 4-bit routing ID field, a 12-bit Req_Size field, a 40-bit Seq_Num field, a 40-bit Address field, a Payload field of at least 1 byte, and a 16-bit End-to-end Cyclic Redundancy Check (ECRC) field.

18. The apparatus of claim 11, wherein
the optical link frame includes a read request optical link frame used when the CPU node or the accelerator node requests data read from the shared memory located in the memory node, and
the read request optical link frame includes a 4-bit OP_Code field, a 4-bit priority field, a 4-bit routing ID filed, a 12-bit Req_Size field, a 40-bit Seq_Num field, a 40-bit Address field, and a 16-bit ECRC field.

19. The apparatus of claim 11, wherein
the optical link frame includes a write response optical link frame for an optical link frame requested by the CPU node or the accelerator node to use shared memory located in the memory node,
the write response optical link frame includes a 4-bit OP_Code field, a 4-bit priority field, a 4-bit routing ID field, a 12-bit Payload_Size field, a 40-bit Seq_Num field, an 8-bit Reserved field, and a 16-bit ECRC field.

20. The apparatus of claim 11, wherein
the optical link frame includes a read response optical link frame for an optical link frame requested by the CPU node or the accelerator node to use shared memory located in the memory node,
the read response optical link frame includes
a 4-bit OP_Code field, a 4-bit priority field, a 4-bit routing ID field, a 12-bit Req_Size field, a 40-bit Seq_Num field, a Payload field of at least 1 byte, a 8-bit Reserved field, and a 16-bit ECRC field.
